(19) United States
(12) Patent Application Publication
(10) Pub. No.: US 2016/0190974 A1
(43) Pub. Date: Jun. 30, 2016

(54) Solar Canopy Assembly Tooling, Method of Assembling a Solar Canopy and a Solar Canopy

(71) Applicant: Lend Lease Americas Inc., New York, NY (US)

(72) Inventors: Matthew DICKEY, Harrisburg, NC (US); Robert GARDNER, Mount Juliet, TN (US); Chris KNIGHT, Charlotte, NC (US); Simon MUIR, Marina Del Rey, CA (US); William C. POULIN, Middletown, MD (US); Justin RIDER, Mountain City, TN (US)

(21) Appl. No.: 14/586,360

(22) Filed: Dec. 30, 2014

(51) Int. Cl. H02S 20/10; H02S 20/23; H02S 40/36; E04F 10/00; H02S 50/10

(52) U.S. Cl. CPC H02S 20/10; E04F 10/005; H02S 50/10; H02S 40/36; H02S 20/23

(57) ABSTRACT

Methods and apparatus for assembling solar canopy subassemblies, and solar canopies formed with such solar canopy subassemblies, are provided. The provided method and solar canopy assembly tooling permit solar canopies to be erected quickly and in a highly efficient and cost-effective manner with high quality solar canopy subassemblies, while simultaneously minimizing hazards to solar canopy erection workers by minimizing the amount of time workers must spend at elevated heights and minimizing the number of workers that may be exposed to hazards of associated with elevated work.

### BACKGROUND AND SUMMARY OF THE INVENTION

The present invention relates to canopies with solar cells, and more particularly to tooling for assembly of canopies with solar cells and to methods for assembling solar canopies with such tooling.

Assembly and erection of large free-standing canopies, such as canopies covering a row of automobile parking spaces or roof-top canopies on top of large commercial buildings such as parking decks, has traditionally required long periods of manual assembly of the many individual components of the canopy (e.g., individual structural support members, individual placement and securing of canopy panels, electrical wiring of the individual panels and connection of the panel wiring to on-site-placed junction equipment). Further, the prior approaches to canopy erection required a large amount of the erection work to be performed by skilled (and thus higher cost) trades workers and technicians, and required much of this extensive fabrication and assembly work to be performed in a hazardous environment, i.e., at elevated heights, either from elevated platforms adjacent to and/or over the canopy structure or on the elevated canopy structure itself.

In addition to the potential hazards faced by the workers at these well ground heights, assembly of such canopies has also typically required the use of multiple pieces of costly heavy lifting equipment, for extended periods, to bring the canopy materials and workers to the required work height. These equipment requirements further increase canopy erection costs and further expose both the elevated workers and those on the ground to hazards that can be created by mishandling of the lifting equipment, such as tipping or uncontrolled dropping of heavy canopy components and/or tools to the ground.

The prior approach to solar canopy erection has effectively resulted in nearly every solar canopy being a custom design, often with the many individual components of the canopy and its support structure having to be fabricated and/or modified on-site to suit the particular installation. As a result, the prior approach typically has required upwards of 30 days for site preparation and the custom fabrication and assembly of the individual canopy structural members and scores or hundreds of individual solar panels required to complete the solar canopy. A further problem is that typically the solar canopy erection teams assembled for these custom installations are employed from the local pool of workers, resulting in an erection workforce with most members having little or no prior experience with solar canopy erection. This further increases costs and canopy erection times as the majority of the new workers must be also trained on the work to be performed at the job site.

In the last decade, there has been a substantial increase in commercial and government facility interest in large canopies equipped with solar panels as a source of energy savings and potential income generation through sale of power to the local electric utility. The projected demand for solar canopies has substantially increased, and is expected to accelerate in coming years. However, the prior approach to solar canopy erection has inherent cost and facility impact problems (such as extended disruption of operations at the customer's facility during an extended canopy erection period) that have rendered the purchase and installation of solar canopies economically and operationally not viable in many cases. These economic and operational limitations are also reflected in the common view in the art that the unique needs of each solar canopy installation site make solar canopy erection not amenable (either logistically or economically) to fabrication and assembly of substantial portions of the solar canopy anywhere but at the installation site, where the various components of the canopy can be fabricated and/or altered on a real-time, as-needed basis to suit the essentially “custom designed” solar canopy.

The present invention addresses these and other problems in the art by use of special solar canopy assembly fixtures and tooling and altering the fundamental approach to solar canopy erection as compared to prior approaches, while at the same time substantially lowering costs, canopy erection times and elevated work hazards.

In the present invention the structural and electrical assembly of the multitude of individual components of the solar canopy are removed from the hazardous elevated work environment, and instead are performed on dedicated fixtures and tooling that permit ergonomic performance of substantially all of the assembly and quality control testing functions at ground level, either on-site or at a remote central manufacturing facility. These fixtures permit highly efficient assembly and testing of transportable, standardized, high quality solar canopy subassemblies that may be quickly transported to the canopy erection site and rapidly placed on top of pre-erected support frames.

In addition to the high quality solar canopy subassemblies provided by this approach, the support frames may also be pre-assembled or assembled on-site (using, for example, simple devices that do not require skilled workers, such as fasteners inserted into pre-driled holes). Once the support frames are made ready for erection at the canopy erection site, they may be erected by simple lifting and placement on pre-formed pylons or other foundations, thereby minimizing the amount of lifting or other heavy construction equipment required at the site. The approach also substantially minimizes the need for welding, cutting or other skilled mechanical assembly work to be performed at the erection site, further reducing costs and erection time and minimizing the size and costs of the crew of on-site workers, most of whom do not have to be the sort of skilled (and thus costly) trade workers required for the prior approach of custom fabrication, modification and/or assembly of a large number of small, individual solar canopy components during an on-site erection effort. The lack of need for a large number of workers further minimizes the need extensive worker training, particularly where the on-site canopy erection team's work tasks are limited to relatively simple operations such as installing bolts and connecting standardized wiring connections, and the on-site workers need only perform a minimal amount of elevated work to rapidly fix the large pre-assembled subassembly panels to their supporting frames and connect the subassemblies' standardized electrical connections to pre-positioned mating connections on the support frame (connections which in turn are arranged to be easily connected to pre-prepared site utility connections such as a local electrical distribution network and communications/data transmission networks). The smaller erection crew requirements and much shorter canopy erection times also help improve the economic viability of the solar canopy process by making it possible to assemble small teams of dedicated, experienced canopy erection workers for dispatch to an erection site for relatively short periods, rather than having to rely on employing usually inexperienced local workers and/or construction contracting firms at each erection site.

The approach of the present invention substantially improves the economic viability of solar canopy installations and greatly minimizes the overall on-site erection activity impact on the facility—anywhere from 4 to 10 times faster erection (e.g., 5 days vs. 30 days to erect a large solar canopy)—while also providing consistently higher quality and reliability of the electrical elements of the completed solar canopy due to their previous testing and verification at ground level during the use of the solar canopy assembly fixtures and tooling.

Preferably the solar canopies are formed from rows of solar canopy subassemblies that are placed with their longitudinal ends on lateral support members of support frames, with these lateral arms being supported preferably on vertical columns, preferably on single vertical columns that support the lateral arms in a cantilevered manner. The present invention is not limited to single vertical support columns or to cantilevered lateral support members. For example, the lateral support members may be fixed at both ends to adjacent vertical columns or be coupled to the facing end of an opposing cantilevered lateral support member located on another support column, or supported simultaneously on more than one column.

Such standardized column arrangements minimize solar canopy material and site preparation costs, as well as minimize customer facility impacts by minimizing the amount of disturbance of the ground and the amount of time that must be devoted to foundation and utility preparation at the erection site. Preferably the support frames are mounted to their small-footprint foundations using mechanical connections, further minimizing or eliminating the need for skilled welders and/or the need to embed the support frames in the foundations (both of which can increase cost and erection times) while also providing for minor mechanical alignment adjustments during erection.

Preferably the solar panels of a solar canopy subassembly are arranged in rows, for example, a single row of seven, eight or nine solar panels (i.e., 1×7, 1×8, 1×9), and have their solar energy collection units provided with standardized lengths of connection cabling and connectors that permit simple and rapid connection of adjacent solar panels' electrical collection units (and any other wiring carried on the canopy) in series. This approach results in solar canopy subassemblies that have single connections at their longitudinal ends that facilitate ease of connection to other subassemblies and to connections at the support frames. The solar panel subassemblies may also be combined into multiple-subassembly strings, such as two subassemblies placed adjacent to one another and connected in series. The subassemblies may also be constructed as mirror images, a feature that permits the subassemblies' single electrical connections at one longitudinal end to be joined, so that the connection of the series-wired solar panels to the support frame can be made at one support frame (the support frame at the opposite longitudinal end of the mirror-image multi-subassembly string).

The total number of solar canopy subassemblies that may be located between adjacent support frames (the support frames preferably being spaced at standardized separation distances) may vary as available space, site geometry and structural load design requirements dictate. For example, multiple adjacent solar canopy subassemblies having a large number of solar panels between adjacent support frames (for example, 60 or 72 solar panels) are possible with the modular nature of the present invention. The support arrangements are not limited to single subassemblies spanning the space between two adjacent support frames, and may include arrangements such as a subassembly having a length long enough to span multiple support frames (for example, a subassembly spanning three support frames with the middle support frame providing support to the central region of the subassembly), as long as the subassembly length is a multiple of the standardized support frame spacing. The erection of a series of such subassemblies and support frames permits large solar energy generation that is proportional to canopy size, for example large solar canopies generating on the order of 500 kW at 600V-1000V.

The assembly fixtures and tooling that have been developed to support the present invention's approach to solar canopy erection are preferably provided with the capability of receiving and aligning a wide variety of sizes and lengths of solar panels and their underlying purlin members, as well as being adjustable to suit multiple solar canopy subassembly lengths and widths. This capability may be facilitated by coupling together two or more subassembly assembly modules to form an assembly fixture that is as long as necessary to provide the desired length of the solar canopy subassemblies being produced.

In order to permit ergonomic, rapid assembly and quality inspection of the subassemblies, the assembly modules are provided with rotatable assembly platforms that are supported on module bases, such that the assembly platforms may be rotated about an axis that is parallel to a longitudinal axis of the solar canopy subassembly. When multiple assembly modules are employed, coupling(s) between the modules align the modules' rotation axes co-axially so that the entire solar canopy subassembly may be rotated to different angles relative to the ground during different assembly operations. The assembly fixtures and tooling also include solar panel alignment guides and guides for positioning the longitudinal purlins to which the solar panels are fixed. These guides are preferably adjustable relative to the assembly platform to support assembly of different solar canopy subassembly configurations, and the solar panel guides may be removable following completion of assembly so that the completed solar canopy subassembly may be easily lifted and removed from the fixture by a forklift or other suitable lifting devices such as an overhead winch or crane.

The solar canopy subassembly fixtures and tooled are arranged so that the assembly platform on which the subassembly components are received is rotatable to place the faces and edges of the solar panels and their supporting purlins at advantageous positions for technicians to perform the various solar panel assembly and electrical connection tasks required, preferably from the side or from above the subassembly. This eliminates difficult work underneath the solar panels and purlins, such as previously had to be performed when all of the individual components of the solar canopy were assembled on-site and at elevated heights. The fixtures and tooling are also arranged to prevent rotation of the assembly platform to an angle at which the subassembly components could fall from the platforms before they are secured to one another. The subassembly fixtures provide for mechanical alignment assurance, as well as electrical continuity and other testing, assuring the string of solar panels is assembled correctly and that all components are functional and installed according to applicable standards and testing requirements prior to lifting into position in the support frames.

Preferably, the solar canopy subassembly assembly begins with the positioning of one or more C-shaped purlins against their guide elements and clamping of the purlins in place, at least until the solar panels are fixed to the purlins. Before or preferably after the purlins are positioned, the solar panels are positioned adjacent to one another along the assembly module with their lateral side edges resting along their longitudinal guide member. The assembly platform may be positioned in a near-vertical position (e.g., between 60 and 90 degrees from horizontal) to facilitate ergonomic installation of fixing elements such as clamp plates, grounding elements and fastening bolts between the adjacent solar panels at pre-determined locations where holes have been provided in the underlying purlins. The assembly platform may be further rotated to a position at which the faces of the solar panels opposite the solar energy collection faces are facing outwards and/or upwards to allow ergonomic making of connections between the standardized electrical collection unit cables and any other electrical wiring. Following quality inspection, the completed solar canopy subassembly may be removed from the assembly module and transported to the canopy erection site.

Use of the assembly fixtures for rapid, high-quality solar canopy subassembly assembly is preferably performed in a central indoor facility, typically remote from the solar canopy erection sites, for efficiency reasons and to permit the assembly to proceed in a weather-protected environment that may be heated or cooled as necessary. The inventive fixtures and tooling may also be transported and located near, or even at, the erection site so that the present solar canopy subassembly assembly methods may be employed at ground level, prior to lifting and simplified installation of the canopy subassemblies on the pre-prepared support frames.

Other objects, advantages and novel features of the present invention will become apparent from the following detailed description of the invention when considered in conjunction with the accompanying drawings.

### BRIEF DESCRIPTION OF THE DRAWINGS

FIG. 1 is an oblique view of a solar canopy in accordance with an embodiment of the present invention.

FIG. 2 is oblique views of another embodiment of a solar canopy in accordance with the present invention.

FIGS. 3, 4a and 4b are elevation views of further embodiments of a solar canopy in accordance with the present invention.

FIG. 4a-4b is oblique cross-section views of a solar canopy arrangement in accordance with an embodiment of the present invention.

FIG. 5 is an oblique view of a solar canopy subassembly in accordance with an embodiment of the present invention.

FIGS. 6a-6d are views of solar panel-to-purlin fixing approaches in accordance with embodiments of the present invention.

FIG. 7 is an oblique view of a lower surface of a solar canopy in accordance with an embodiment of the present invention.

FIG. 8 is an oblique view of the placement of completed solar panel subassemblies on support frames in accordance with an embodiment of the present invention.

FIGS. 9-13 are various views of solar canopy subassembly fixture tooling in accordance with an embodiment of the present invention.

FIGS. 14-15 are detailed oblique views of support and clamp devices carried on the solar canopy subassembly tooling of FIGS. 9-13.

Reference numerals for similar components are used throughout the drawings, without intent to indicate the similar components are identical in different embodiments.

### DETAILED DESCRIPTION OF THE DRAWINGS

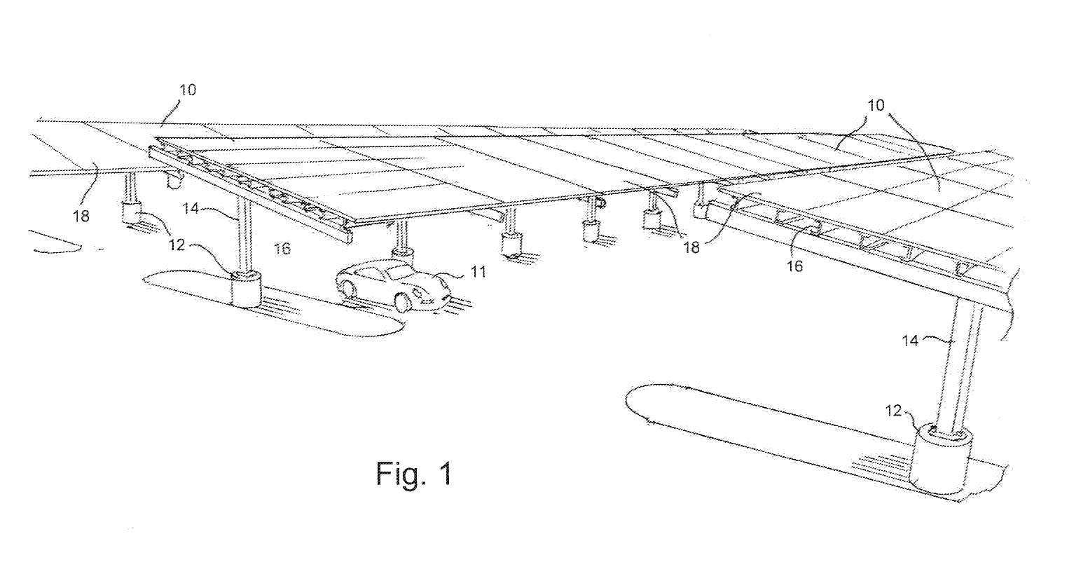

FIG. 1 illustrates a solar canopy installation in accordance with an embodiment of the present invention in which three canopies 10 are shown installed in a vehicle parking lot, with a vehicle 11 shown for approximate scale. In this embodiment the framework of each of the canopies 10 is supported on pylons 12 using generally T-shaped frames 14. The upper surface of the T-frames 14 in this embodiment are angled from horizontal toward the sun to maximize solar energy collection, and support a series of purlins 16 that in turn support a plurality of solar panels 18. Preferably the ground support structure for the solar canopy, whether above, at or below ground level, is constructed using standardized components (for example, standardized concrete foundation forms), enabling rapid pre-canopy erection site preparations with minimum disruption to surrounding facilities and activities. In certain circumstances and when desirable, alternative ground support structures may be used, such as metal and or metal/concrete hybrid structures.

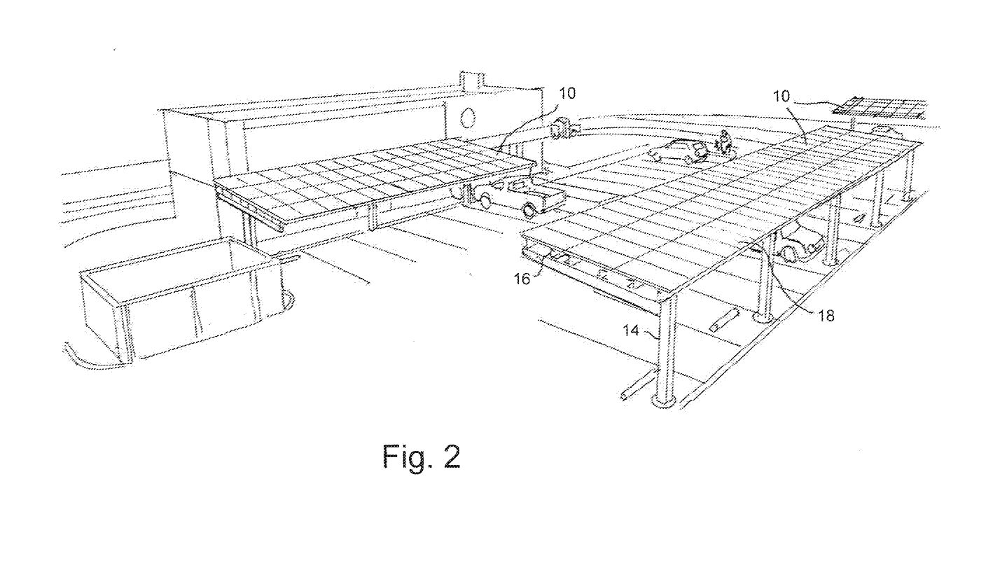

FIG. 2 illustrates an alternative canopy support frame embodiment in which the canopies 10 are supported on generally L-shaped support frames 14, with the solar panels 18 and purlins 16 being carried in a cantilevered manner on the L-shaped frames 14. Other supporting frame arrangements are possible, such as a cantilever with a partially balancing portion on the opposite side of the vertical frame member (e.g., a frame having the vertical member positioned approximately ⅓ the length of the frame's purlin supporting arms), as long as the frames provide a sufficient support of the purlin and solar panel subassemblies (the subassemblies are described further, below).

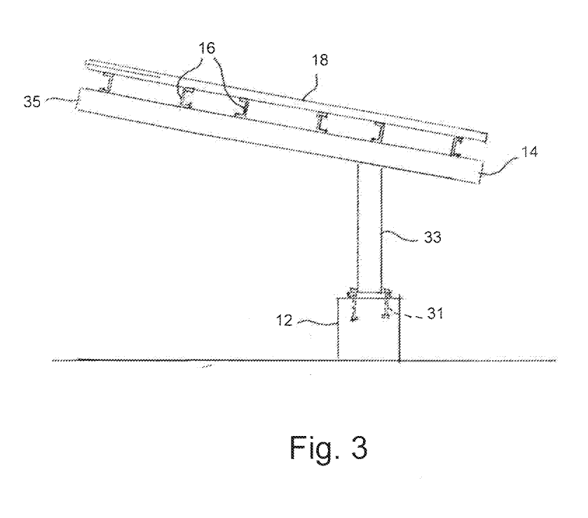

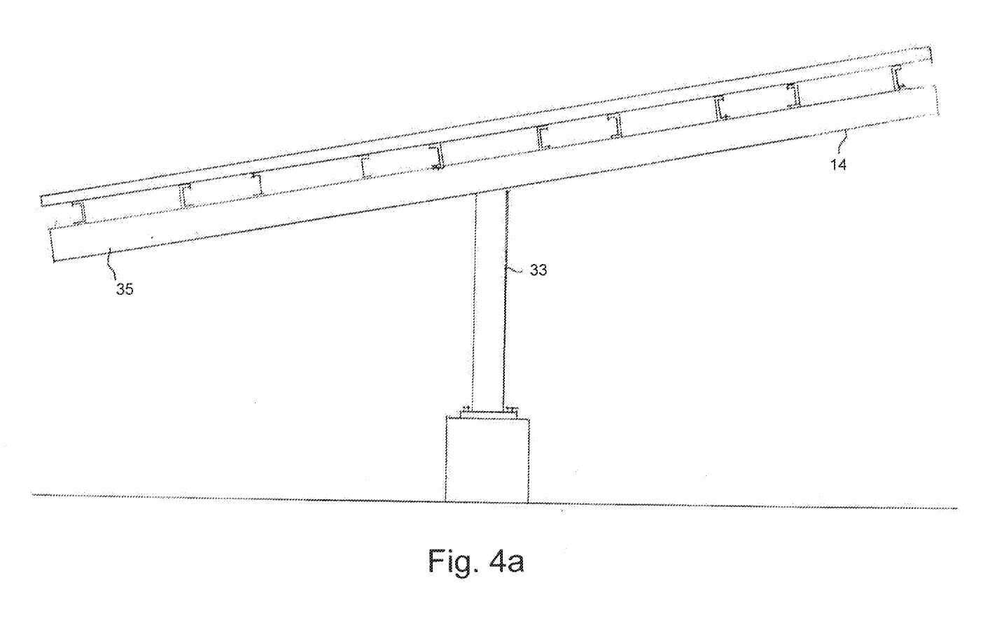

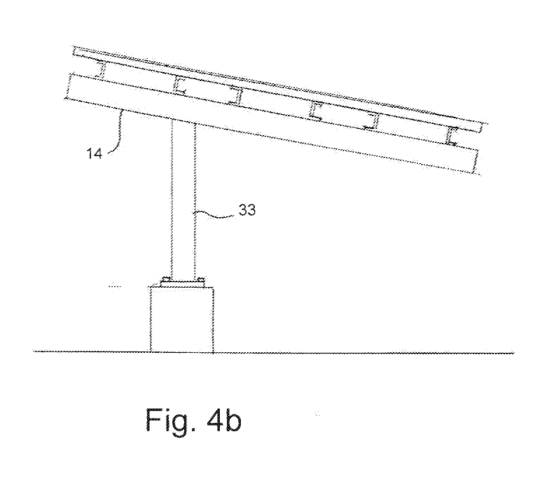

FIG. 3 is an elevation view of a cantilever frame arrangement with a counter-balancing portion showing a foundation arrangement for pylon 12, preferably standardized column base to aid in rapid erection of the canopy structure, having a vertical member 33 of a T-shaped frame 4 attached by fasteners 31. The lateral member 35 of the T-frame is arranged in this embodiment with approximately ¾ of its length on one side of the vertical member 33, and ¼ of its length to the opposite side of vertical member 33. A plurality of solar panel-supporting purlins 16, in this embodiment a series of C-shaped beams, are fixed to the upper surface of the T-frame lateral member 35. The C-shaped purlins 16 carry a plurality of solar panels 18. FIGS. 4a and 4b show alternative arrangements, with FIG. 4a showing a “balanced” canopy arrangement with a T-frame 14 having a vertical member 33 at approximately the middle of the T-frame's lateral member 35, and FIG. 4b showing a partially-cantilevered T-frame 14 similar to that of FIG. 3, but with the larger cantilevered portion on the lower side of the canopy relative to the T-frame's vertical member 33.

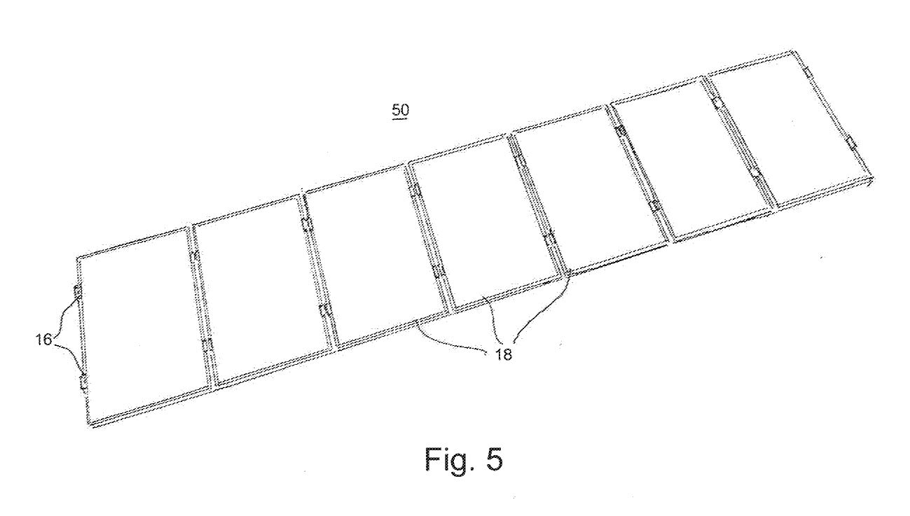

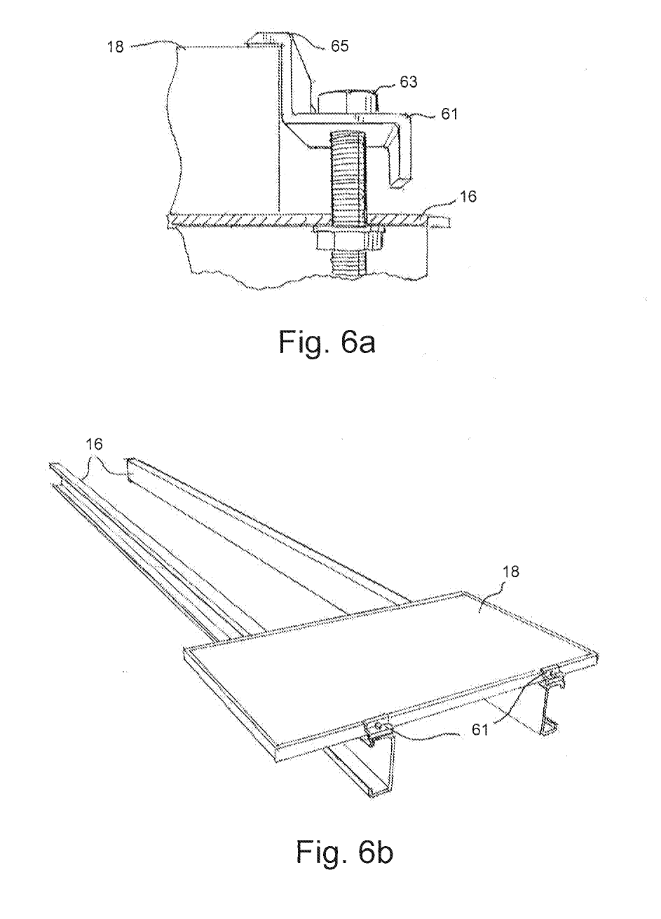

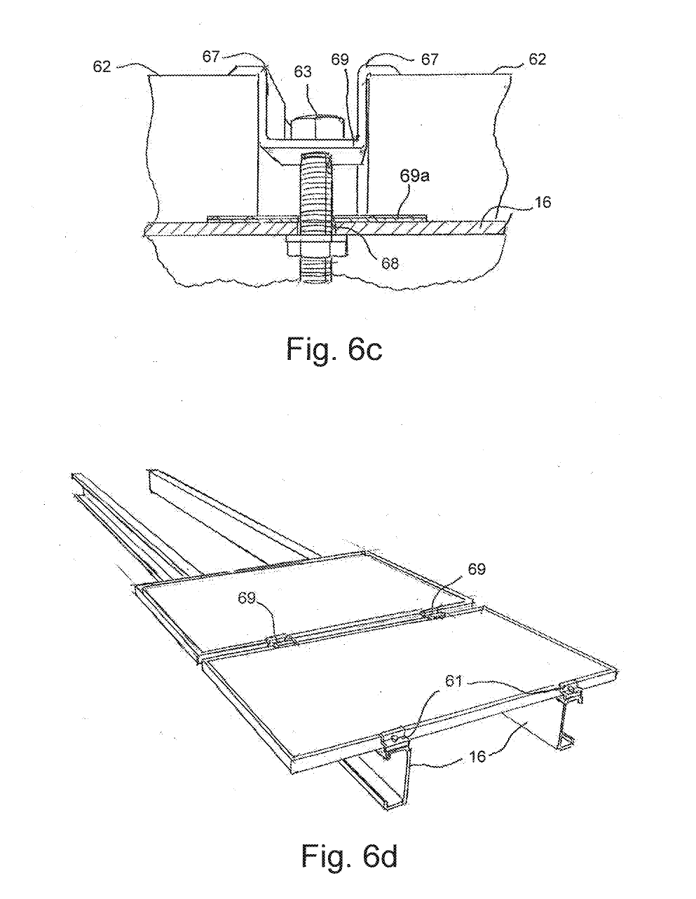

FIG. 5 shows an embodiment of a solar canopy subassembly 50 having seven standardized solar panels 18 in series supported on their underside by two purlins 16. The number of purlins may be greater than two, and if structurally adequate for a particular solar canopy installation may be reduced to one. The purlins 16 in this embodiment are pre-drilled at regular intervals, on a spacing adapted to the standardized solar panels 18, to receive fasteners associated with hold-down devices that fix the solar panels 18 to the purlins 16. Examples of such hold-down devices in the form of clamping members are shown in FIGS. 6a-6d. In this embodiment the hold-down devices are secured by bolts, however any securing device arrangement that securely couple the solar panels to the purlins may be used, such as rivets, self-tapping screws, fasteners that couple to pre-installed attachment devices on the purlins (for example, a nut tack-welded to the purlin that is arranged to receive a threaded fastener to permit the hold-down device to be secured from one side of the subassembly without a worker having to be present on the opposite side).

FIG. 6a shows a hold-down clamp device 61 and fastener 63 securing a solar panel 18 to one end of the C-shaped purlins 16 that will form the backbone of the solar canopy subassembly, as shown in FIG. 6b. The hold-down end clamp device 61 in FIG. 6a has only one side with a solar panel holding flange 65, given its location and a longitudinal end of the subassembly. FIGS. 6c and 6d show the hold-down device arrangements inserted between adjacent solar panels 18 along the solar canopy subassembly, in which a double-sided hold-down clamp device 69 has opposing flanges 67 that position the adjacent solar panels 18 at a standardized distance, with a fastener 63 securing the hold-down device 69 to the each purlin 16 at pre-positioned holes 68 in the top of the C-channel purlin 16. The arrangement shown in FIG. 6c includes a grounding device 69a that may be provided located between the purlin and the solar panel to ensure effective grounding of the solar panel to the purlin. The grounding device may be for example an electrical equipment bonding plate or bracket such as the WEEB® washers available from BURNDY LLC of Manchester, N.H. that are configured to penetrate an anodized layer to provide direct metal-to-metal conductivity between the purlin and the solar panel.

The assembly of the solar canopy subassembly continues in a similar fashion along the purlins until the last of the seven solar panels in this embodiment is secured at the opposite end of the purlins 16 by hold-down claim devices 69 between the last of the adjacent solar panels and by hold-down clamp devices 61 at the ends of the purlins 16.

In the embodiment in FIGS. 6a-6d, each purlin 16 receives a hold-down clamp device at the edges of the lateral sides of the solar panels 18. Other arrangements are possible as long as the solar panels are sufficiently securely located on the purlins for the site at which the solar canopy is to be erected. For example, only one clamp device could be used between each pair of adjacent solar panels, with the single clamp device location between solar panels alternating between the purlins along the length of the subassembly The purlins may also be arranged with open sections all facing in the same direction or opposite directions, and may be combined to form a single purlin, such as by collocating two C-shaped purlins back-to-back to form an I-beam-like structure.

The purlins underlying the solar panel subassemblies are C-shaped in the foregoing embodiments, but may be any beam shape that is both structurally adequate to support the solar panels in the design environmental conditions and provides for access for receiving and securing the solar panels during assembly of the solar panel subassemblies and during subsequent fixing of the subassemblies to the canopy support frames at the canopy erection site.

Similarly, while the hold-down clamp devices are secured to the purlins by fasteners in the foregoing embodiments, other securing approaches well known in the art may be used, such as welding, riveting or clamping by an intermediate retaining device such as a clip, as long as the solar panels are securing fixed to the purlins in the solar panel subassembly. Further, the securing devices may be formed from any suitable material, such as steel, Aluminum, plastic and/or composite materials.

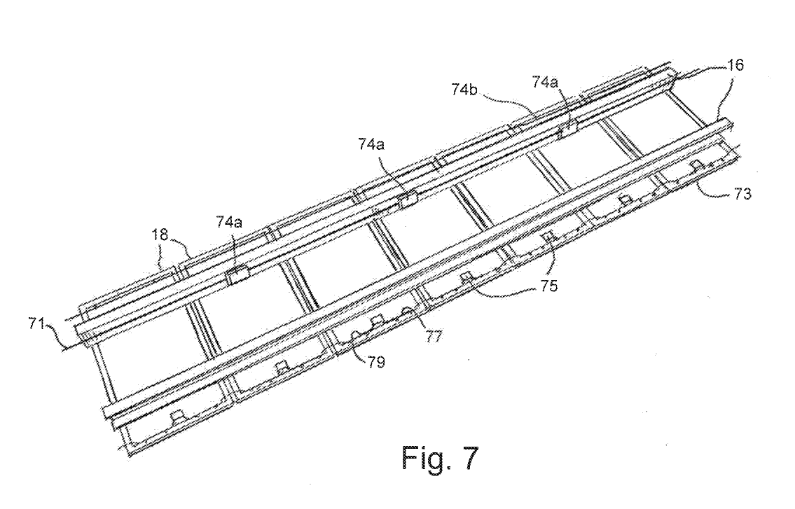

FIG. 7 illustrates the electrical arrangements of the solar canopy subassembly. In this embodiment each solar panel 18 on the side 71 opposite the solar energy collection side 73 is provided with an electrical collection unit 75 that receives the electrical energy generated by the solar panel. Each collection unit 75 is provided with an input cable 77 and an output cable 79 having standardized connectors and lengths sufficient to permit the sub assemblies' solar panels to be connected to create a series-wired subassembly with subassembly inlet and an outlet connections at the opposite longitudinal ends of the subassembly. Preferably the collection units 75 are located toward a lateral side of the solar panels near a purlin 16, so that loose cabling may be secured to the adjacent purlin or the lateral edge of the solar panels, for example by wire stays. Preferably any cable between securing points is positioned within the C-shaped of the purlin or directly at an edge frame of the solar panel to provide protection for the cables and improve the aesthetics of the underside of the solar canopy.

Similarly, wiring connections for other electrical components such as lighting units 74a located on one or more of the solar panels 18 and/or the purlins 16, and/or continuous wire runs 75b that extend along the entire length of the solar panel subassembly (for example, wires that link communications components located several support frames apart) may be laid out in the same manner to provide inlet and outlet connections at opposite ends of the solar canopy subassembly, or run continuously from one subassembly to the next.

While other electrical connection arrangements between the solar panels are possible (for example, parallel or hybrid series-and-parallel arrangements), the present invention's approach to modular electrical component connection facilitates rapid, simple, high quality connection of the electrical lines in a production environment and minimizes costs, both by minimizing assembly labor costs and minimizing material use, such as minimizing cable lengths.

The present invention is not limited to lighting or solar collection units, but may include other components supported on the solar panel subassembly or purlins, such as microinverter units, DC converters and/or optimizers.

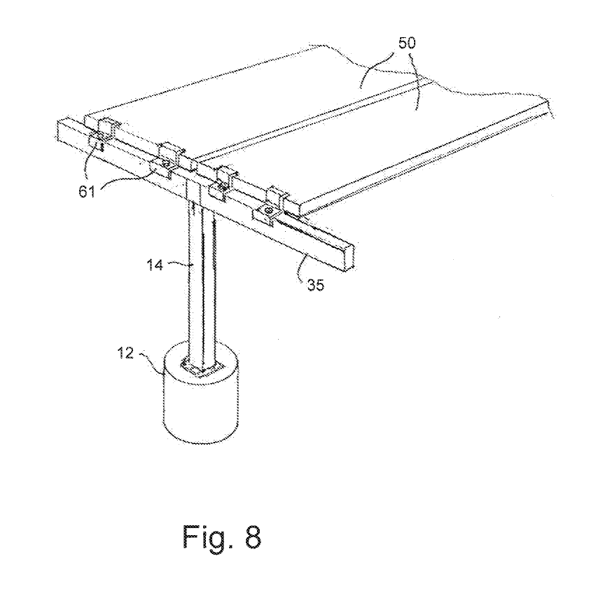

Following remote assembly of the subassemblies (discussed further, below) and their transport to the solar canopy erection site, as shown in FIG. 8 two or more subassemblies 50 may be lifted into position onto the upper surface of an adjacent pair of lateral support frame members 35 of the T-frames 14 to complete the canopy portion between adjacent support frames. As one or more of the solar canopy subassemblies 50 is located on the lateral frame members 35 the workers may proceed to fix the subassemblies to the lateral frame members, for example using fasteners through pre-positioned holes in the lower portion of the purlins 16 that align with pre-positioned holes in the upper surfaces of the lateral frame members 35. As with the solar panel subassemblies, other approaches to securing the subassemblies 50 to the lateral frame members 35, such as riveting, may be employed. Once located on the lateral frame members 35, the inlet and outlet cable connections at the ends of the solar canopy subassemblies made be completed with adjacent solar canopy subassemblies and/or to connections supported on the support frames (such as connections that deliver collected solar energy-generated electricity to an electrical distribution network).

The transport and attachment of solar panel subassemblies to the awaiting frame members provides a significant reduction in hazard exposure to the solar canopy erection workers by replacing many hours of elevated work building up the canopy structure from individual components (typically requiring substantial custom-fitting of frame structures and solar panels to build the canopy) with very limited work above ground. Following erection of the supporting ground structure, which mostly occurs at or near ground height, the limited elevated work is primarily the rapidly securing (for example, bolting) of the solar canopy subassemblies to the pre-installed support frame members (a process expedited by the pre-arranged attachment points, for example, standard location bolt holes), and the making of electrical cable connections (i) at the ends of the subassemblies to adjacent subassemblies (often referred to as “source circuits”) and/or (ii) the making of common electrical connections at each end of the subassemblies at the supporting frames (often referred to as “output circuits”) that are in turn connected to combiner circuits that are then connected to electrical inverters for the purpose of inverting from DC to AC, or directly to inverters that can accept multiple source circuits. The output circuits can result from combining source circuits, such as at a combiner box, with an electrical output that is either DC or if a DC to AC inverter is used, AC.

In addition to substantial reduction in hazard exposure to the workers and the ergonomic benefits that translate into greater worker productivity and job satisfaction, the present approach to solar canopy construction also permits canopy erection labor costs to be significantly reduced, as fewer workers (including fewer skilled trade workers) are needed at the canopy erection site.

There are a number of possible approached to electrical connection of multiple subassemblies to one another and to the electrical collection points at the support frames. For example, where two solar canopy subassemblies are positioned adjacent to one another, each subassembly's end electrical connections could be individually connected to a central combiner box on one or both of the support frames on which the subassemblies are secured. Alternatively, mirror-image subassemblies may be placed adjacent to one another with their edges near their respective electrical collection units being positioned next to on another such that a single connection could be made between the subassemblies at one end to create a series arrangement of twice the number of solar panels, with both subassemblies at their other ends each presenting an electrical connection to the doubled series circuit to electrical connections at a single support frame member (i.e., eliminating the need to provide canopy-to-ground utility connections at every support frame member). In another arrangement, the solar panels may include, individually or in pairs, an AC microinverter or another type of power conditioning and management electronics. These device arrangements may be wired one to another, in a parallel or series connection. This arrangement also may be fully facilitated, performed and tested on the subassembly fixture.

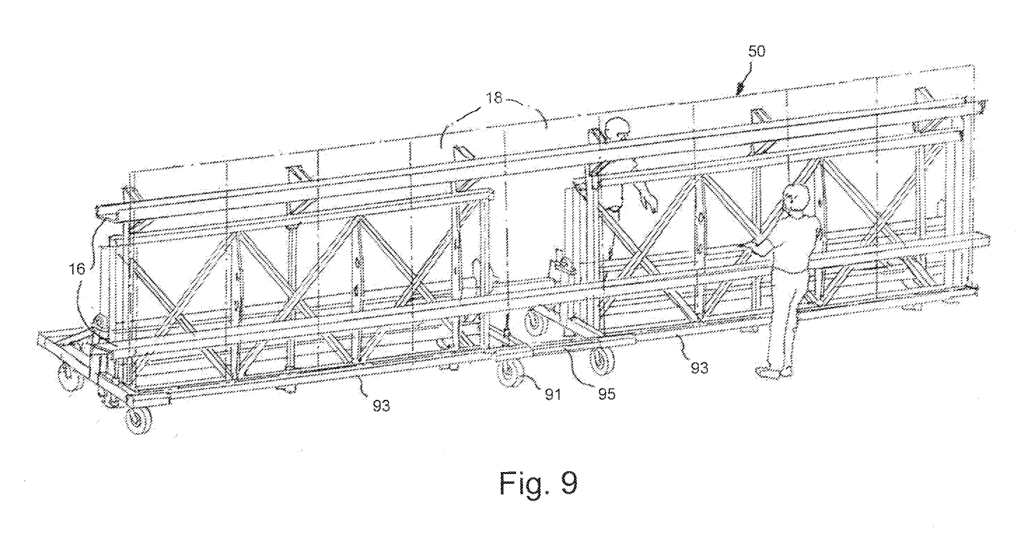

The remote assembly of the solar canopy subassemblies is facilitated and made economically viable in part due to the use of canopy subassembly tooling that provides the ability to assemble the subassemblies with unprecedented efficiency and consistency. An embodiment of such tooling is shown in an oblique overview manner in FIG. 9. In this embodiment a completed solar canopy subassembly 50 including solar panels 18 and purlins 16 is shown in position on a subassembly fixture 91. The fixture 91 here is formed from two standardized assembly modules 93 that are joined and aligned by connecting members 95. In this embodiment the assembly modules 93 are separated a distance corresponding to the assembly offline solar panels 18 to the purlins 16. The distance between adjacent assembly modules 93, the number of assembly modules 93 and the lengths of the standardized purlins may be varied as need to suit the width and number of solar panels 18 to be fixed to the solar canopy subassembly 50.

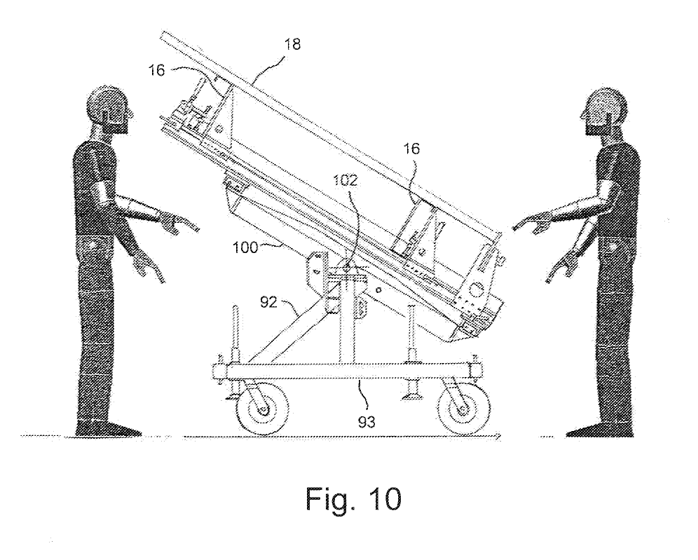

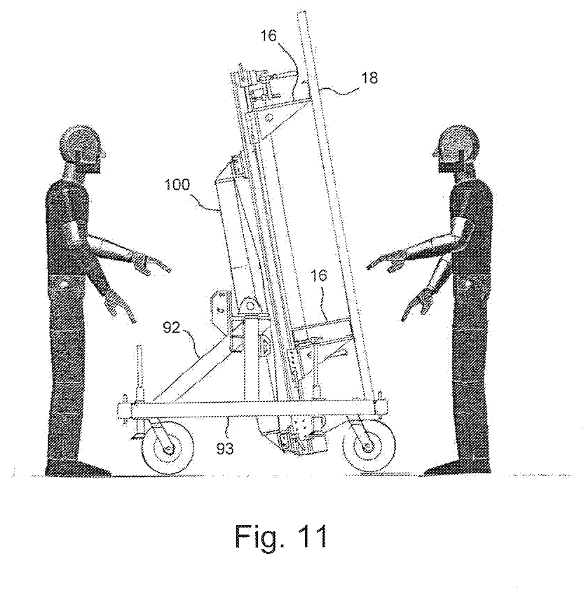

A feature of this subassembly tooling embodiment that significantly contributes to efficient and uniform assembly of the solar canopy subassemblies is the mounting of the solar panel subassemblies on a pivoting assembly platform 100 of the subassembly fixture 91 that pivots on a support base 92 about a common longitudinal axis 102 of the assembly modules 93. This arrangement permits the solar canopy subassembly to be pivoted during the various stages of assembly into positions that permit ergonomically favorable access to the components of the subassembly, as shown in FIGS. 9-13. The pivoting action may be performed manually, or may be motorized. The arrangements may also be counter-balanced to ease rotation.

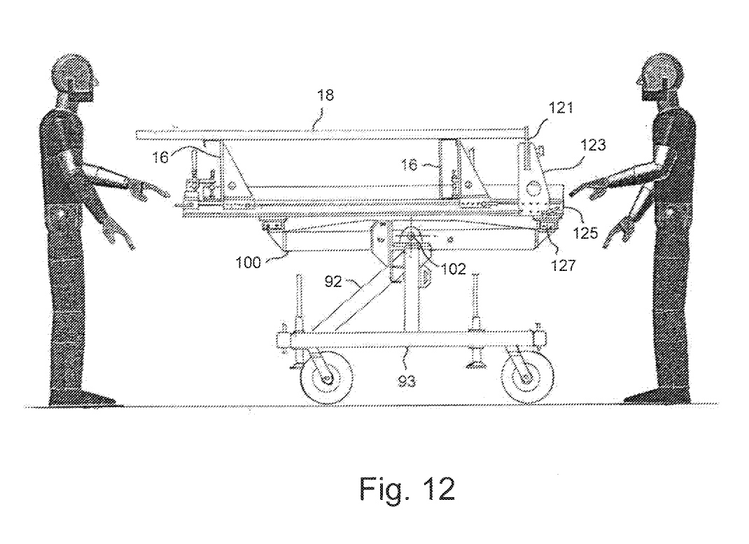

FIG. 12 illustrates several of the features of the inventive fixture that permit rapid, highly uniform and high quality assembly of solar canopy subassemblies, while also maintaining substantial flexibility to accommodate a variety of solar panel and purlin shapes and sized. Along at least one side of the solar canopy subassembly a longitudinal guide rail 121 is provided for alignment of the sides of the solar panels 18 on a common datum before the solar panels are fixed to their underlying purlins 16. This alignment may be conducted in any rotational position of the pivoting assembly platform 100, however, the alignment is preferably accomplished as the solar panels are located on to the pivoting assembly platform in a generally near-vertical position, such as is illustrated in FIG. 9, before fixing to the purlins 16. The FIG. 9 near-vertical position also facilitates ergonomic and more rapid attachment of hold-down clamp devices between the solar panels to the underlying purlins by placing the solar energy-collecting face of the solar panels directly in front of a worker. The generally near-vertical position is also advantageous for interconnection of the solar panel electrical connections during assembly of the solar panel subassembly, as the generally upright position allows technicians to also have access to the purlin side of the subassembly. This provides for ergonomic assess to the electrical collection units 75 located on each solar panel, while at the same time eliminating the need to expose technicians to the hazard associated with making and testing potentially hundreds of such connections at elevated heights during an on-site erection of a large solar canopy.

The longitudinal guide rail 121 is removably held in this embodiment in guide rail clamp members 123. The guide rail clamp members 123 may be re-positioned along transverse frame members 125 that are generally perpendicular to the longitudinal rotation axis 102 of the assembly fixture, as needed to suit the size of the solar panels and the entire solar canopy subassembly configuration currently being assembled. Further the transverse frame members 125 may be movable along longitudinal frame members 127 as needed to accommodate the solar canopy subassembly currently being assembled.

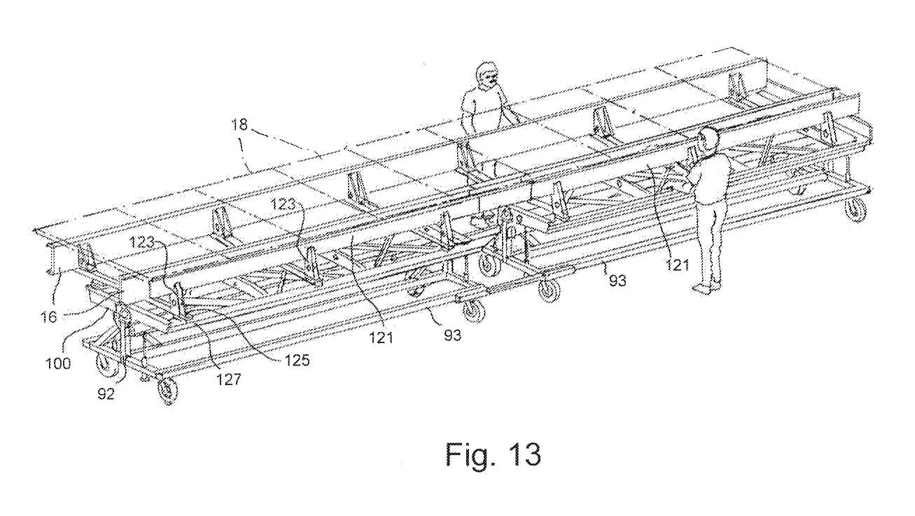

Upon completion of the solar panel subassembly, pivoting assembly platform 100 may be rotated to the horizontal position shown in FIGS. 12 and 13, and the guide rail 121 removed to permit lifting of the completed subassembly off of the assembly fixture, for example by lateral insertion of the tynes of a forklift under the completed subassembly.

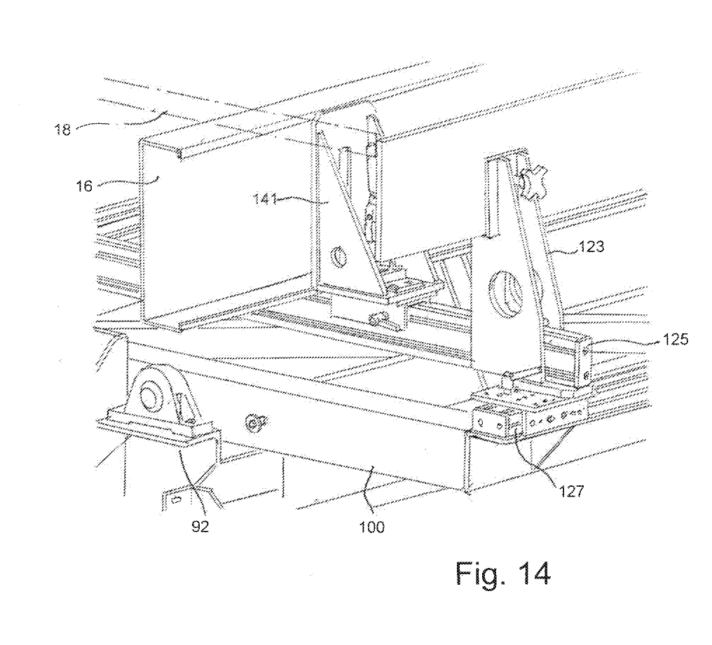

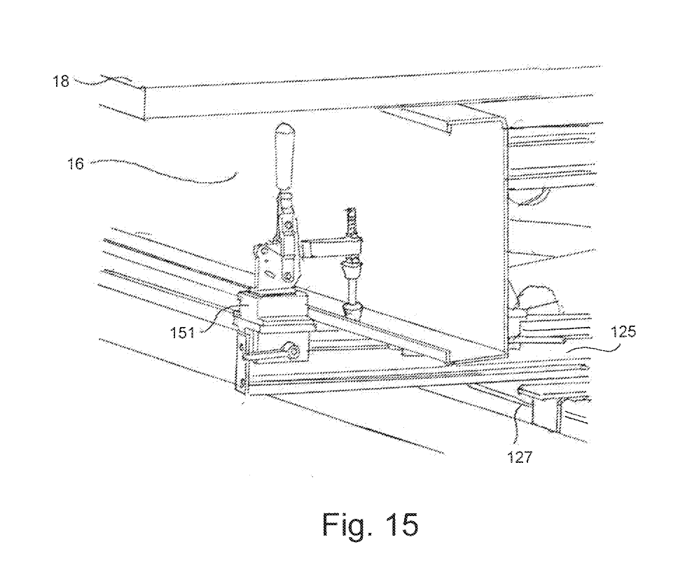

The purlins 96 are positioned on the assembly fixture by purlin guide members 141, as shown in detail in FIG. 14. In this embodiment the purlin guide members 141, like the guide rail clamp members 123, as located on the transverse frame members 125. During assembly of the solar canopy subassemblies the pivoting assembly platform 100 may be rotated to a generally upright position such as shown in FIGS. 9-11, and the purlins 16 placed on the purlin guide members 141 to aligned and hold the purlins 16 while the solar panels 18 are set into place on the longitudinal guide rail 121 and then fixed to the purlins. Once placed against the purlin guide members 141 the purlins may also be held in place as shown in FIG. 15 by clamp devices 151, in this embodiment manual clamps with compressible rubber tips that bias the purlins 16 to the transverse frame members 125.

The foregoing disclosure has been set forth merely to illustrate the invention and is not intended to be limiting.

For example, solar canopy panel units need not be assembled in linear arrays, but may be in any array form conducive to assembly on a suitably configured rotating solar canopy assembly device and subsequent transport to an erection site for placement on support beams. For example, the panel unit array may be formed as a curve, a combination of curved and straight sections, and/or rectangular array with securing devices arranged both between adjacent solar panels in each row and between solar panels of adjacent rows. In another embodiment, more than one longitudinal guide rail may be provided on the pivoting assembly platform, thereby permitting two or more rows of solar panels to be assembled into standardized subassemblies at the same time, either as subassemblies that can be removed separately from the fixture or as a larger multi-row assembly of subassemblies.

Because other such modifications of the disclosed embodiments incorporating the spirit and substance of the invention may occur to persons skilled in the art, the invention should be construed to include everything within the scope of the appended claims and equivalents thereof

Listing of reference labels:

10 solar canopy

11 vehicle

12 pylon

14 support frame

16 purlin

18 solar panel

31 fastener

33 support frame vertical member

35 support frame lateral member

50 solar canopy subassembly

61 hold-down clamp device

63 fastener

65 flange

67 flange

68 hole

69 hold-down device

69a grounding device

71 solar panel side away from the energy collection side

73 solar panel solar energy collection side

74a lighting unit

74b wire run

75 solar energy electrical collection unit

77 input cable

79 output cable

91 subassembly fixture

92 support base

93 assembly modules

95 connecting member

100 pivoting assembly platform

102 common longitudinal axis

121 longitudinal guide rail

123 guide rail clamp member

125 transverse frame member

127 longitudinal frame member

141 purlin guide member

151 clamp device

What is claimed is:

1. A solar canopy assembly fixture configured to support assembly of a solar canopy subassembly having a plurality of solar panels, comprising:
at least one solar canopy subassembly assembly module;
a solar panel assembly platform supported on a support base of the at least one assembly module, the assembly platform being rotatably mounted on the support base to rotate about a rotation axis;
a plurality of purlin fixing members arranged to fix at least one purlin on the assembly platform with the at least one purlin aligned parallel to the rotation axis of the assembly platform;
at least one solar panel alignment guide aligned parallel to the rotation axis and arranged to provide an alignment reference surface for mutual alignment of a lateral edge of each of the plurality of solar panels;
wherein the assembly platform is rotatable about the rotation axis between positions that permit opposite faces of the solar canopy subassembly to be accessible for assembly operations without a need to access the faces of the solar canopy subassembly from below the subassembly.

2. The solar canopy assembly fixture of claim 1, wherein
the plurality of purlin fixing members are arranged to support at least one purlin aligned parallel to the rotation axis.

3. The solar canopy assembly fixture of claim 2, wherein
the plurality of purlin fixing members are position adjustable in a direction transverse to the rotation axis.

4. The solar canopy assembly fixture of claim 2, wherein
the plurality of purlin fixing members are position adjustable in a direction transverse to the rotation axis to predetermined locations corresponding to predetermined purlin separation distances.

5. The solar canopy assembly fixture of claim 2, wherein
the plurality of purlin fixing members are located on a plurality of assembly platform transverse frame members aligned in a direction transverse to the rotation axis.

6. The solar canopy assembly fixture of claim 5, wherein
at least one of the plurality of transverse frame members is adjustable to different axial positions parallel to the rotation axis.

7. The solar canopy assembly fixture of claim 2, wherein
the at least one solar panel alignment guide is adjustable in a direction transverse to the rotation axis to predetermined locations corresponding to predetermined offsets between lateral edges of the plurality of solar panels and a nearest purlin of the at least one purlin.

8. The solar canopy assembly fixture of claim 2, wherein
the at least one solar panel alignment guide is removable to facilitate removal of an assembled solar canopy subassembly from the solar canopy assembly fixture.

9. The solar canopy assembly fixture of claim 2, wherein
the plurality of purlin fixing members and the at least one solar panel alignment guide are located on the plurality of transverse frame members.

10. The solar canopy assembly fixture of claim 2, wherein
the plurality of transverse frame members are position adjustable along at least one assembly platform longitudinal frame member that is parallel to the rotation axis.

11. The solar canopy assembly fixture of claim 1, wherein
the at least one solar canopy subassembly assembly module includes at least two assembly modules coupled such that their respective assembly platforms are co-axial on the rotational axis.

12. A method of assembling a solar canopy subassembly having a plurality of solar panels, comprising the acts of
adjusting a solar canopy subassembly assembly module to receive components of a solar canopy subassembly for assembly thereon, the assembly module including
a solar panel assembly platform supported on a support base of the at least one assembly module, the assembly platform being rotatably mounted on the support base to rotate about an rotation axis,
a plurality of purlin fixing members arranged to fix at least one purlin on the assembly platform with the at least one purlin aligned parallel to the rotation axis of the assembly platform, and
at least one solar panel alignment guide aligned parallel to the rotation axis and arranged to provide an alignment reference surface for mutual alignment of a lateral edge of each of the plurality of solar panels;
wherein the assembly platform is rotatable about the rotation axis between positions that permit opposite faces of the solar canopy subassembly to be accessible for assembly operations without a need to access the faces of the solar canopy subassembly from below the subassembly;
fixing the at least one purlin to the assembly platform with the plurality of purlin fixing members;
placing two of the plurality of solar panels adjacent to one another on the at least one purlin with a lateral edge of each of the two solar panels adjacent to one of the at least one solar panel alignment guide;
fixing the two of the plurality of solar panels to the at least one purlin with at least one securing device positioned in a gap between the two adjacent solar panels;
rotating the solar panel assembly support fixture about the rotation axis;
establishing electrical connection between electrical collections units of each of the two adjacent solar panels; and
removing the assembled solar canopy subassembly from the solar canopy assembly module.

13. The method of claim 12, wherein
the at least one purlin is at least two purlins aligned parallel to the rotation axis.

14. The method of claim 13, further comprising the acts of
placing the remaining solar panels of the plurality of solar panels on the assembly platform in a row aligned with said two of the plurality of solar panels;
fixing the remaining solar panels to the at least two purlins with additional securing devices positioned in gaps between adjacent solar panels; and
establishing electrical connections between adjacent solar panels such that an electrical collection unit of a solar panel of the plurality of solar panels at a first end of the row is electrically connected to an electrical collection unit of a solar panel of the plurality of solar panels the solar panel at an opposite end of the row.

15. The method of claim 14, wherein the electrical collection units of the plurality of solar panels are located on a face of the solar panels opposite a solar energy collection face.

16. The method of claim 15, wherein
the act of fixing the plurality of solar panels to the at least two purlins is performed with the assembly platform positioned at a first angle relative to the ground, and
the act of establishing electrical connection between adjacent solar panel electrical collection units is performed with the assembly platform rotated about the rotation axis to a second angle relative to the ground.

17. The method of claim 16, where
the first angle and the second angle are selected such that the acts of fixing the solar panels to the at least two purlins and of establishing electrical connection between the electrical collection units of adjacent solar panels are performed when assembly platform is substantially vertical such that the acts do not require access to the faces of the solar canopy subassembly from below the subassembly.

18. The method of claim 13, wherein
the at least one securing device comprises a flange extending over an edge of at least one adjacent solar cell, and
the flange is fixed either directly or via intermediate members to one of the at least two purlins.

19. The method of claim 18, wherein
each of the at least one securing device flanges is fixed to one of the at least two purlins by a fastener.

20. The method of claim 19, wherein
each of the at least one securing device flanges is fixed to one of the at least two purlins by a bolt.

21. The method of claim 14, further comprising the acts of
performing at least one of mechanical testing and electrical testing of the solar canopy subassembly after completing the fixing of the plurality of solar panels and the establishing of electrical connections.

22. A method of erecting a solar canopy, comprising the acts of
assembling a plurality of solar canopy subassemblies, each of the solar canopy subassemblies being assembled by the method of claim 12;
transporting the plurality of solar canopy subassemblies to a solar canopy erection site;
placing the plurality of solar canopy subassemblies on at least one lateral support member of at least one canopy support frame;
fixing the plurality of solar canopy panel units to the at least one lateral support member; and
electrically connecting electrical collection units of each of the plurality of solar canopy subassemblies to at least one support frame connection.

23. The method of claim 22, further comprising the act of
connecting the at least one support frame connection to an electrical distribution network.

24. The method of claim 22, wherein
the at least one lateral support beam is at least two support beams, each located on one of the at least one canopy support frames.

25. The method of claim 24, wherein
each of the plurality of solar canopy subassemblies is fixed to the at least two lateral support beams by at least one of a fastener and welding.

26. The method of claim 25, wherein
each of the plurality of solar canopy subassemblies is fixed to the at least two lateral support beams by at least one bolt.

27. A solar canopy, comprising
at least two solar canopy subassemblies, the solar subassemblies each including at least one purlin supporting a plurality of solar panels arranged adjacent to one another in at least one row, the plurality of solar panels of each of the at least two solar canopy subassemblies being fixed to the respective at least one purlin of each subassembly by securing devices and each of the plurality of solar panels having electrical collection units electrically connected to the electrical collection units of adjacent solar panels by electrical connections on a face of the solar panels opposite a solar energy receiving face;
at least two support lateral support members of a support frame, the at least two lateral support members having the at least two solar canopy subassemblies fixed thereon;
at least vertical support member of the support frame from to which the at least two lateral support beams are fixed.

28. The solar canopy of claim 27, wherein
at least two of the at least two solar canopy subassemblies are mirror-image structures, and
the mirror-image structures are arranged with respective solar panel edges adjacent to one another with at least one electrical connection between the electrical collection units extending between the mirror solar canopy subassemblies across the adjacent solar panel edges.
